(19) United States
(12) Patent Application Publication
(10) Pub. No.: US 2008/0222286 A1
(43) Pub. Date: Sep. 11, 2008

(54) Computer Usage Monitoring

(76) Inventor: Kevin I. Plumpton, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/029,522

(22) Filed: Feb. 12, 2008

(30) Foreign Application Priority Data
Feb. 12, 2007 (NZ) 553157

(51) Int. Cl. G06F 15/173

(52) U.S. Cl. 709/224

(57) ABSTRACT

The present invention relates to a method of monitoring worker activity in a work group, the work group comprising workers each using a computer on a computer network their method comprising displaying to a work group supervisor, in consolidated form, a label indicating each worker and information indicating the current activity and/or classification determined for each worker.

### FIELD OF THE INVENTION

The present invention relates to the monitoring of the computer usage activity of multiple users in an organisation, such as in a Contact Centre.

### BACKGROUND OF THE INVENTION

It has become acceptable practice for employers to monitor the computer usage of their employees. This might include monitoring the usage of applications and internet, and other activities carried out by users on their computers.

Key logging monitoring software is currently used, although this does not provide clear indications of the type of applications and work the user is carrying out. Remote desktop software is also used to monitor users, although this is cumbersome for a large number of users.

These software monitoring applications only provide low-level monitoring to detect inappropriate usage or rely on the user to enter what they are doing such as worktime in a Contact Centre. They do not provide information that supervisors can use to more effectively manage their staff and productivity.

### SUMMARY OF INVENTION

It is an object of the invention to provide a system, software and/or method to assist in monitoring the computer usage of multiple users. This is by way of providing information to a supervisor regarding use by the users.

In one aspect the present invention may be said to consist in a method of monitoring worker activity in a workgroup, the workgroup comprising workers each using a computer on a computer network, the method comprising: for each worker, obtaining information from their computer regarding the identity of the user, and the worker's current activity on the computer and/or telephone, displaying to a workgroup supervisor, in consolidated form, a label indicating each worker and information indicating the current activity and/or classification determined for each worker, wherein the worker's current activity is determined from one or more of the following on the worker's computer: application(s) being used, file(s) currently open, active window(s) that the application(s) are using, data within window(s), and input from keyboard and mouse activity.

Preferably a classification is determined from a database entry that corresponds to the current activity.

Preferably the supervisor advising one or more workers to change their current activity based on their current activity and the status of incoming calls.

Preferably the method further comprises: for each operator, obtaining information relating to the time spent on the current activity, and displaying the time spent on any existing call to the supervisor in consolidated form.

Preferably the method further comprises displaying to one or more workers their determined current activity and classification, and receiving input from one or more workers for changing the determined current activity and/or classification.

Preferably the information indicating the current activity and/or classification of each worker is displayed in real time or substantially real time.

Preferably the information indicating activity and/or classification of each worker is historical information obtained earlier.

Preferably the current activity relates to a computer application currently being used by an operator.

Preferably the current activity relates to telephone usage.

Preferably the current activity is determined as idle, wherein idle indicates that a computer is not being used.

In another aspect the present invention may be said to consist in a system for monitoring worker activity in a workgroup, the workgroup comprising workers each using a computer on a computer network, the system adapted to: for each worker, obtain information from their computer regarding the identity of the user, and the worker's current activity on the computer and/or telephone, display to a workgroup supervisor, in consolidated form, a label indicating each worker and information indicating the current activity and/or classification determined for each worker, wherein the worker's current activity is determined from one or more of the following on the worker's computer: application(s) being used, file(s) currently open, active window(s) that the application(s) are using, data within window(s), and input from keyboard and mouse activity.

In another aspect the present invention may be said to consist in a method of monitoring worker activity in a workgroup, the workgroup comprising workers each using a computer on a computer network, the method comprising: one or more workers answering and handling incoming calls and/or work, for each worker, obtaining information from their computer regarding the identity of the user, and the worker's current activity on the computer and/or telephone, displaying to a workgroup supervisor, in consolidated form, a label indicating each worker and information indicating the current activity and/or classification determined for each worker, wherein the worker's current activity is determined from one or more of the following on the worker's computer: application(s) being used, file(s) currently open, active window(s) that the application(s) are using, data within window(s), and input from keyboard and mouse activity, and the workgroup supervisor managing the workers based on the displayed information to improve productivity.

### BRIEF DESCRIPTION OF THE DRAWINGS

Preferred embodiments of the invention will be described with reference to the following drawings, of which:

FIG. 1 is a flow diagram outlining use of a computer usage monitor,

FIG. 2 is a flow diagram of a method of monitoring computer usage,

FIG. 3 is a block diagram of a client computer terminal for an operator,

FIG. 4 is a block diagram of an alternative client computer terminal for an operator,

FIG. 5 is a block diagram of a system for implementing monitoring,

FIGS. 6a to 7b show screen shots of the computer usage monitor in use,

FIG. 8 is a block diagram of an alternative system that monitors telephone usage,

FIG. 9 is a block diagram of an alternative system comprising a remote operator.

### DETAILED DESCRIPTION OF PREFERRED EMBODIMENTS

The present invention relates to a system, method and/or software for monitoring computer usage by workers in a workgroup. A workgroup can be any group of workers that carry out tasks. For example, it might comprise a number of call operators in a contact or call centre, or a team working in an office environment. The invention is not restricted to such examples, and it could be used for any group of workers. The monitoring information provided by the invention can be utilised by a supervisor of the workgroup. The supervisor can broadly be any type of overseeing personnel such as a monitor, manager, supervisor or any one else who might want/need to monitor the activities of workers in a workgroup. The present invention will be described in relation to a contact centre, by way of example.

The invention relates to a method of monitoring computer usage, along with a system and software for enabling that method. The invention can be used to manage staff activities and improve productivity. The system might be considered the entire computer network comprising user computers, supervisor computers, the network and other hardware for operating the system.

Alternatively, the system can just be considered the hardware that operates monitoring and real-time reporting. This might include the workers' computers and/or the supervisor's computers. The monitoring software itself can be considered in a logical sense a single entity, although physically it might be resident and executing on separate machines remote from each other, but operating in a unified manner. The method can be operated on a machine, or also comprise one or more users operating a machine to achieve the invention.

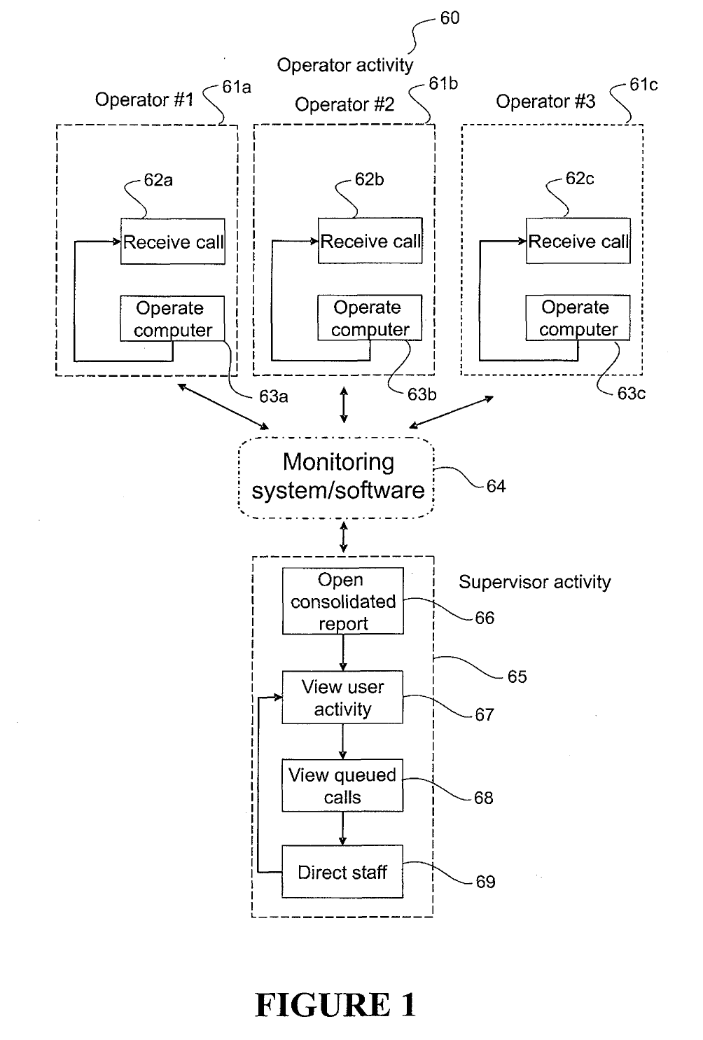

FIG. 1 shows an overview 60 of how a preferred embodiment is utilised. A number of Contact Centre operators 61a-61c (which are workers) are employed to receive calls and deal with the enquiries. Dealing with an enquiry might involve carrying out a task on a computer using a computer application, the internet, or some other activity. In this specification, when an operator uses a computer, they can also be termed a user or worker, and the computer or activity they are carrying out will be termed the current activity.

When the worker receives a call 62a-62c or other task, they handle it in the usual way, which may involve utilising their computer 63a-63c. During this time, the monitoring system/software 64 of the preferred embodiment will determine the current activity of the worker, and any other worker using their respective computer. It can create a consolidated report indicating the current activities of all or a subset of all the worker. Preferably, the report is a real time or quasi/substantially real time report.

At desired times throughout the day, a supervisor 65 in the Contact Centre can monitor the operator staff they are responsible for. To do so, they can open or obtain a consolidated 66 on screen or printed report relating to the staff. They can view the current activity 67 of each of the operators they are responsible for, and also if required 68 the current calls in the queue. They can then make decisions/directions about operator management 69, based on the current activity of each operator, and the current status of the queue.

For example, a Contact Centre might have a large number of incoming calls waiting in a queue. While some of the operators might be pre-occupied with handling those calls and operating their computers in relation to the calls, other operators might be pre-occupied with mundane administrative tasks, or doing non-work related activity such as surfing the internet. The report will make this immediately obvious to the supervisor, which will enable the supervisor to take appropriate action. This may involve directing non busy operators to take calls. It might also involve reassigning staff from other duties in order to take calls to reduce a backlog.

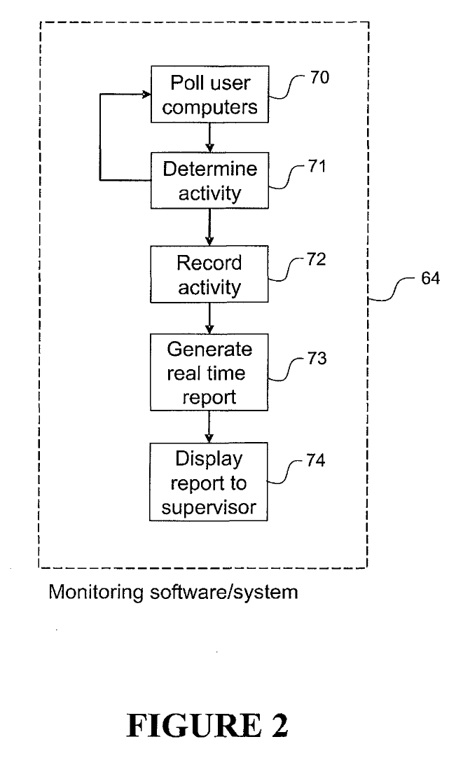

FIG. 2 shows an overview of the method carried out by the real time monitoring software/system (generally called the monitor) according to a preferred embodiment. As mentioned previously, this might be distributed over remotely operated hardware. The monitor polls, step 70, each of the computers of the operators to determine current activity, step 71. It records, step 72, this activity and then can generate a real time report, step 73, and provide/display this to a supervisor, step 74. The monitor is implemented with three modules comprising client side data capture, central data repository and Contact Centre integration.

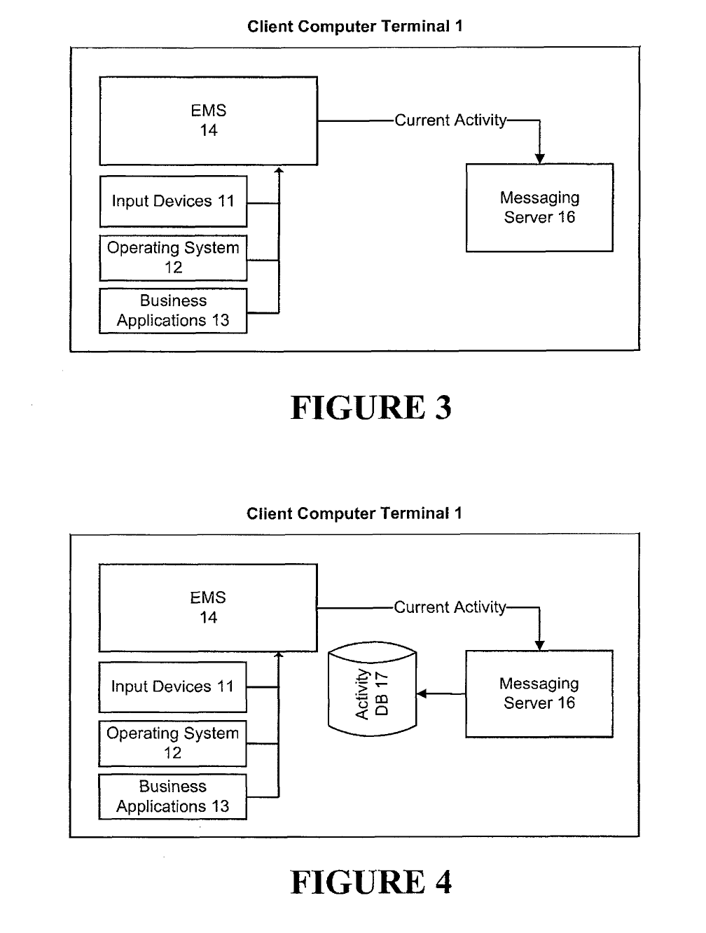

FIG. 3 shows an embodiment of the Client Computer Terminal 1 an operator could utilise in, further detail. The Client Computer Terminal 1 is configured with one or more Input Devices 11, an Operating System 12, one or more Business Applications 13 (which may consist of but are not limited to word processing applications, spreadsheet applications, e-mail client applications and web browsers). This list is not exhaustive. The Client Computer Terminal 1 also comprises a monitoring application the Event Monitor Service (EMS) 14 and a Messaging Server 16 that is an optional component but illustrated to show communications between the users Client Computer Terminal 1 and Activity Server 2.

FIG. 4 shows an alternative Client Computer Terminal 1, which also comprises a local Activity Database 17. This can cumulatively store the data generated by the monitoring application for use in report generation. This might be instead of or as well as the database in the data server. This enables preservation of data in the event of network failure or allows the user to work offline and resyncronise later.

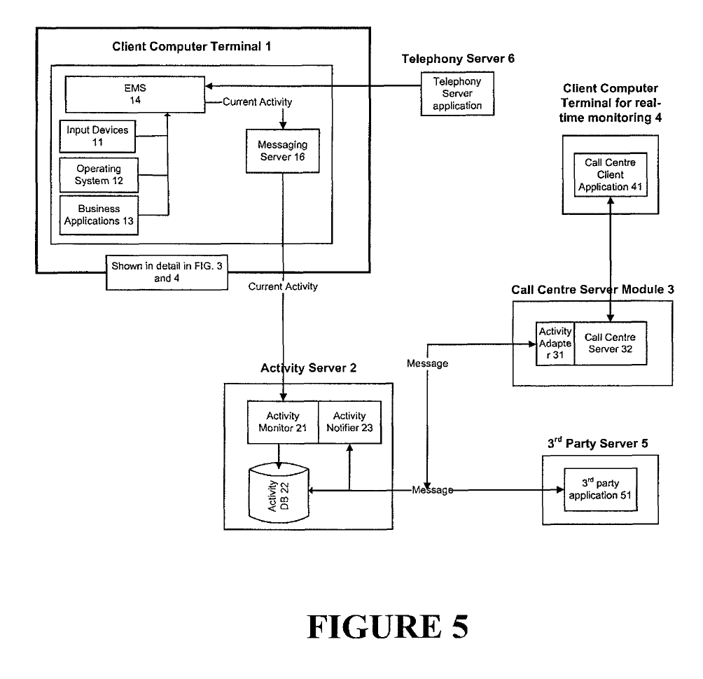

FIG. 5 is a high level logical block diagram of a real-time monitoring system according to an embodiment of the present invention. This is just one possible implementation, and those skilled in the art will realise other configurations are possible.

The system preferably comprises a Client Computer Terminal 1 for use by each user (only one is shown here for clarity, but there could be any suitable number) that is connected to an Activity Server 2 which in turn is connected to a Contact Centre Server 3 which in turn is connected to another Client Computer Terminal for real-time monitoring 4. A Third Party Server 5 is also connected to the Activity Server 2. A Telephony Server 6 is also connected to the Client Computer Terminal 1 to provide Telephony activity for the user.

The main function of the EMS 14 is to track all activities the user engages in and the associated time period spent on the activity. The EMS 14 receives communication from all input devices 11, the operating system 12, and all business applications 13 signifying events have occurred.

The operating system 12 is used to detect: 1) user input from 11 by using Mouse and keyboard hooks, 2) all windows by Enumerating Windows APIs, 3) text in different fields within windows, 4) application names, 5) open files and their directories, 6) registry settings

Accurately interpreting worker requires different techniques for different types of applications used as applications behave differently and may contain multiple activities within them. The system intelligently estimates or determines the current activity and/or classification of that activity.

For example, a user may have open one word processor but several documents each a different activity. Also a user may have open several emails at once also related to different activities.

The EMS 14 processes the following types of information to best determine the activity. It may use any combination of:—

1) Detecting the active Window from the Operating System 12.

2) Enumerating Windows within the Operating System 12 to obtain and use all active windows.

3) Checking text fields on each window 12 for example to determine the customer name within a service application or the sender of an email or the document or spreadsheet title in Word or Excel or website URL.

4) Using the Operating System 12 to determine active files opened and the directory they are in.

5) Reading the registry to find an applications active filename.

6) Detecting calendar information from a Calendaring application or Business Applications 13.

7) Business Applications 13 themselves indicating the users current activity.

8) Using Mouse and Keyboard hooks from 11 detected in 12 to be notified of mouse and keyboard activity that allows us to determine actual time on each activity on the computer and/or where the input is focussed. By tracking the activities window time active and setting time to Idle where there is no keyboard or mouse activity for a predetermined time we can calculate time used rather than time open. Optionally Idle time can be used to prompt the user what happened for non-computer activity. For example the user could say they were reading a document related to project X that could be used to set activity to Reading and classify it to project X covered later.

9) after detecting and tracking an activity the EMS 14 also closes the activity when the associated window is closed.

### Examples of how the EMS may calculate an activity are

1) finding the active Excel spreadsheet by finding the active window, then finding the owner application is Excel, then looking at the titles of the sub root windows to determine each open spreadsheet. Then detecting the sub window receiving the users input from mouse and keyboard to determine the active spreadsheet and hence user activity.
2) Finding a customer being serviced by finding the active window, then finding the owner application is ServiceApplication, then looking at a text field in the main window to read the customers name.
Note other options exist using the techniques above and the Event Monitor is tuned for different techniques per application and types of activities. Outlook for example may have open simultaneously both tasks and emails with different techniques for analysing both.

The EMS 14 notifies the Messaging Server 16 that a new activity is currently active and when it is closed. These notifications are then forwarded to the Activity Server 2.

The Activity Server 2 contains an Activity Monitor 21 that collates all the current activities for Client Computer Terminals 1. This information is then communicated to an Activity database 22, which provides a central data repository. The Activity Notifier 23 then relates this information to interested connected applications, in this embodiment the information is related through to the Contact Centre Server 3 and the Third Party Server 5 via the Activity Notifier 23.

The Contact Centre Server 3 on the network has a module which interprets the activity change notifications sent through from the Activity Notifier 23 and updates the Contact Centre data as applicable. This information is then transmitted to the Contact Centre Client Applications 41 located on the Client Computer Terminal for real-time monitoring 4. Only one Contact Centre Client Application 41 located on a Client Computer Terminal for real-time monitoring 4 is shown in this embodiment, but there could be many. It should be noted that the activity information transmitted through to the Contact Centre Server Module 3 or the third Party Server 5 can be done so either directly or with the Activity Notifier 23 and the Activity Adapter 31.

The information is displayed to the supervisor via the Client Computer Terminal for real-time monitoring 4 as a consolidated report in summarised form. The supervisor can obtain an overview of the current activities of each operator in real time without the need to individually monitor each computer operator's activity. In addition, the supervisor might employ the monitoring unit to display the accumulated records stored in the database to obtain a history of one or more current activities of one or more operators.

In addition to determining current activity, the monitoring application can classify an activity, or this can be classified by the operator. The classification is the type or nature of the current activity, such as a project name, client matter, activity type, or the like. Where used the classification is also written to the databases and can be displayed by the supervisor. The classification can be determined from the title of the activity. To do this the EMS 14 can look for a match in any of the available databases or use the directory name of the file the activity relates to. Where the database is used it refers to the last matching activity with the same name and uses its stored classification if any.

Optionally in addition on the users screen the current activity and or classification can be displayed and the user can optionally decide to change the values.

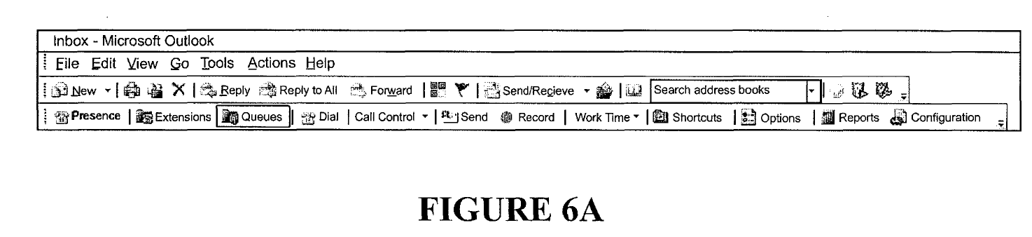

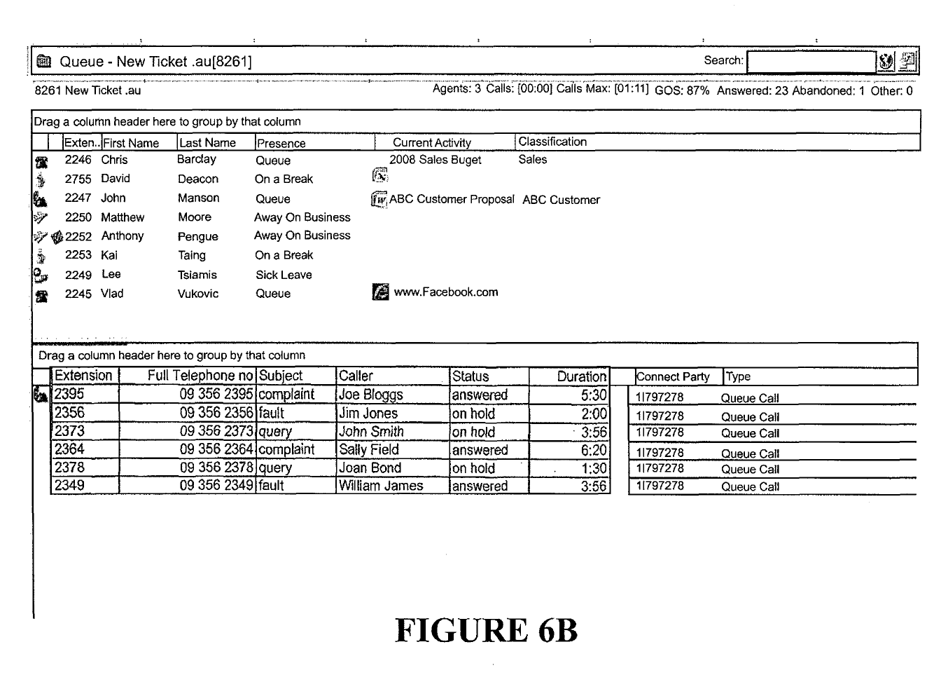

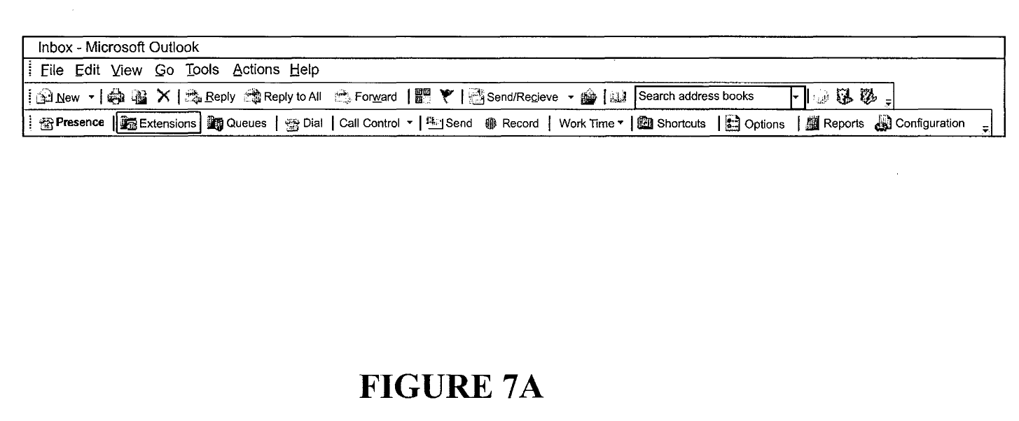

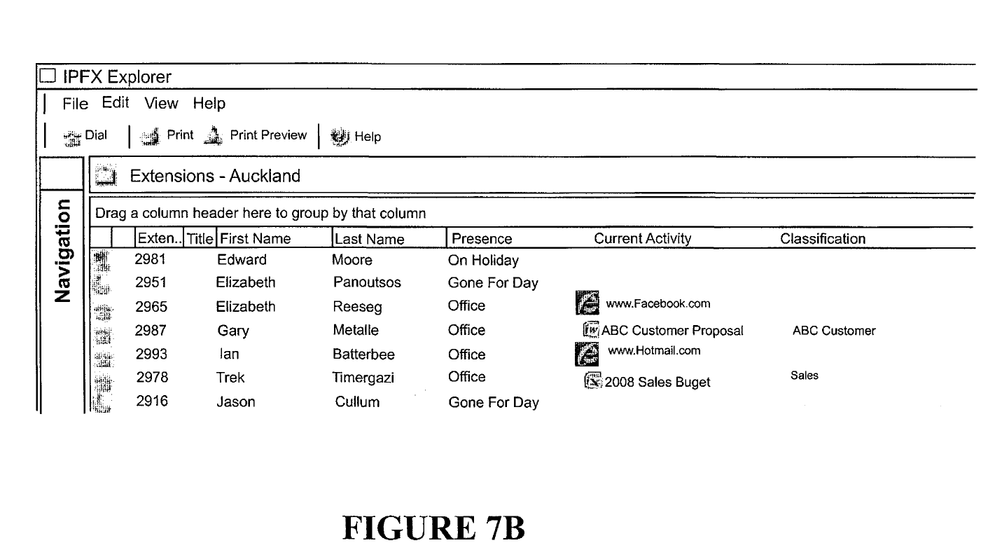

The manner in which the invention is used will now be describe in relation to FIGS. 6a-7b. These Figures show screen shots of user activity when utilising the monitor, as described in relation to FIGS. 1 and 2. First, as shown in FIG. 6a, the supervisor can request a consolidated operator current activity report by pressing the appropriate “queue” button. The monitoring unit then obtains the required information or consolidated report and displays this to the supervisor on the monitoring unit, as shown in FIG. 6b.

The consolidated report shows a label (such as a name) indicating all the operators currently being monitored, along with their current activity. This could be an indication of the application they are using, the website they are currently viewing, the file they are current working on or any other activity. This will be the activity determined by the monitoring application as described above. The information reflects the real time or substantially real time current activity. It could also be updated in real time, or upon request by the supervisor. The information relates to all operators or subset of them that the supervisor is responsible for. Preferably, a list of the queued calls currently unattended is also shown. The consolidated report enables the supervisor at a glance to determine the status of the call queue, determine the activities of all the operators and make a decision as to whether manager intervention is required to improve productivity.

The consolidated report can optionally comprise additional information such as the extensions of an operator, their presence (status), the current activity classification, the time spent on the current activity, and any other useful information that is obtained. It can also comprise information about each operator's telephone activity, as described below.

FIG. 7b shows a consolidated activity report on subset of operators (such as a division or team) when requested by pressing an extension's button as shown in FIG. 7a. Alternative embodiments of the invention are possible.

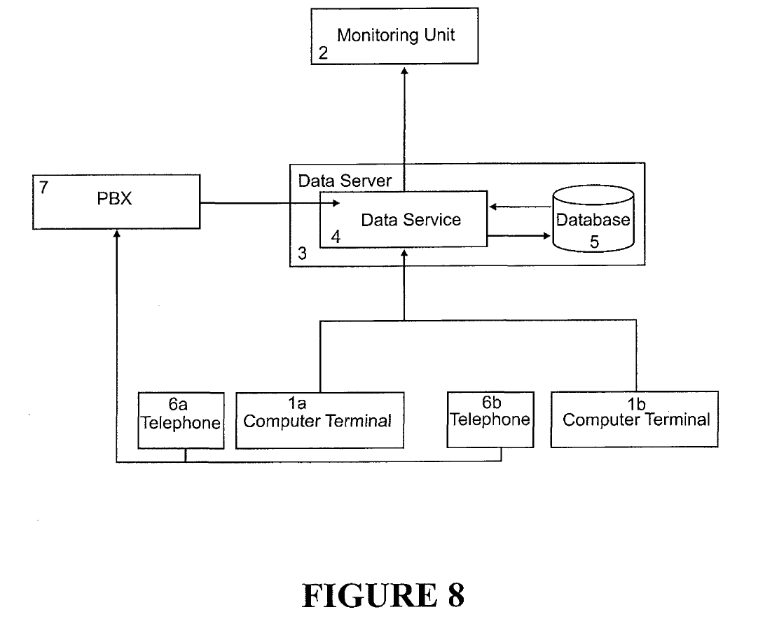

As shown in FIG. 8, the preferred embodiment might be further configured to allow a supervisor to combine information about a computer operator's telephone activity with the current activity information generated by the monitoring applications. In addition to the hardware described in relation to FIG. 3, each operator has a telephone that is connected to a PBX. As a computer operator makes and receives calls, the state of the computer operator's telephone is transmitted from the telephone via the PBX to the data server. The data service then transmits the state of the telephone to the monitoring unit where it is combined with the current activity data and incorporated into the consolidated report, as shown above.

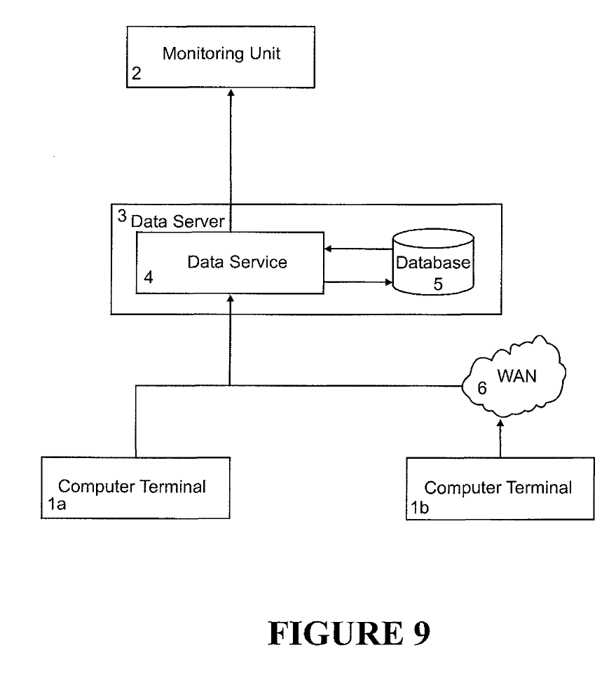

FIG. 9 shows a further variation where a supervisor can monitor in real time the tasks performed by a remote worker. Here, one of the operators works remotely via a WAN, for example at home. The monitoring application running on the remote computer terminal transmits data about the computer operator's activity across the WAN to the data service, which in turn transmits the data to the monitoring unit. Here it is aggregated with other current activities of other operators and displayed to the supervisor in consolidated form. In this manner, the supervisor can monitor activity of remote workers.

1. A method of monitoring worker activity in a workgroup, the workgroup comprising workers each using a computer on a computer network, the method comprising:
for each worker, obtaining information from their computer regarding the identity of the user, and the worker's current activity on the computer and/or telephone,
displaying to a workgroup supervisor, in consolidated form, a label indicating each worker and information indicating the current activity and/or classification determined for each worker,
wherein the worker's current activity is determined from one or more of the following on the worker's computer: application(s) being used, file(s) currently open, active window(s) that the application(s) are using, data within window(s), and input from keyboard and mouse activity.

2. A method according to claim 1 wherein a classification is determined from a database entry that corresponds to the current activity.

3. A method according to claim 1 further comprising the supervisor advising one or more workers to change their current activity based on their current activity and the status of incoming calls.

4. A method according to claim 1 further comprising: for each operator, obtaining information relating to the time spent on the current activity, and displaying the time spent on any existing call to the supervisor in consolidated form.

5. A method according to claim 1 further comprising displaying to one or more workers their determined current activity and classification, and receiving input from one or more workers for changing the determined current activity and/or classification.

6. A method according to claim 1 wherein the information indicating the current activity and/or classification of each worker is displayed in real time or substantially real time.

7. A method according to claim 1 wherein the information indicating activity and/or classification of each worker is historical information obtained earlier.

8. A method according to claim 1 wherein the current activity relates to a computer application currently being used by an operator.

9. A method according to claim 1 wherein the current activity relates to telephone usage.

10. A method according to claim 1 wherein the current activity is determined as idle, wherein idle indicates that a computer is not being used.

11. A system for monitoring worker activity in a workgroup, the workgroup comprising workers each using a computer on a computer network, the system adapted to:
for each worker, obtain information from their computer regarding the identity of the user, and the worker's current activity on the computer and/or telephone,
display to a workgroup supervisor, in consolidated form, a label indicating each worker and information indicating the current activity and/or classification determined for each worker,
wherein the worker's current activity is determined from one or more of the following on the worker's computer: application(s) being used, file(s) currently open, active window(s) that the application(s) are using, data within window(s), and input from keyboard and mouse activity.

12. A method of monitoring worker activity in a workgroup, the workgroup comprising workers each using a computer on a computer network, the method comprising:
one or more workers answering and handling incoming calls and/or work,
for each worker, obtaining information from their computer regarding the identity of the user, and the worker's current activity on the computer and/or telephone,
displaying to a workgroup supervisor, in consolidated form, a label indicating each worker and information indicating the current activity and/or classification determined for each worker,
wherein the worker's current activity is determined from one or more of the following on the worker's computer: application(s) being used, file(s) currently open, active window(s) that the application(s) are using, data within window(s), and input from keyboard and mouse activity, and
the workgroup supervisor managing the workers based on the displayed information to improve productivity.
